(19) United States
(12) Patent Application Publication
(10) Pub. No.: US 2023/0196381 A1
(43) Pub. Date: Jun. 22, 2023

(54) System, Method And Apparatus For Verified Mailing Documents And Process Preparation

(71) Applicant: David A. Jackson, Phoenix, AZ (US)

(72) Inventor: David A. Jackson, Phoenix, AZ (US)

(21) Appl. No.: 17/644,796

(22) Filed: Dec. 17, 2021

(51) Int. Cl. G06Q 30/00; G06Q 50/32; G06F 21/32

(52) U.S. Cl. CPC G06Q 30/0185; G06F 21/32; G06Q 50/32

(57) ABSTRACT

A system, method and apparatus for verified mailing documents and process preparation are disclosed. The disclosed comprise of a trusted agent, being a device adapted for secure verification of a person or entity that transmits a certified mailed document, a data source or engine from whose data a verified document may be generated, a mailing request recipient means adapted to receive requests to mail and/or transmit a certified document to an address of service, and a verification means to verify the authenticity of a requesting person or entity, preferably using biometric authentication means.

### TECHNICAL FIELD

The present invention, in some embodiments thereof, generally relates to secure and verified mailing documents preparation and transmission via a mailing system or service.

Further, the present invention relates to preparation of verified/certified documents for purposes including mailing, verification and similar use cases.

### BACKGROUND OF THE INVENTION

In the postal industry, there is an ongoing transformation to improve service delivery by developing new technologies and devices to perform methods in new automated ways. Most notable is the rise of mobile devices in the day to day postal activities. Portable computing devices are now becoming a tool of choice with some postal service providers having some sort of a channel to provide customers with the ability to order for shipping of letters via a computing device, mobile or desktop. Also, the use of credit cards and debit cards to conduct transactions on merchant portals and premises is well known.

However, there are well known security challenges in the sector, mostly fraud. This is especially a big challenge when mailed documents may communicate important information, such as credit rating, legal contracts, official communication and other important types of documents. Mail fraud is highly illegal in the United States, and also in other jurisdictions around the world. There are numerous incidents of transmission of fraudulent mail documents since the current mailing systems have no way of ensuring that only verified senders can transmit verified documents, while ensuring ease of use. A secure system would be desirable since a secure exchange of information can be guaranteed.

In the United States, mail fraud is any attempt to commit some type of fraud (deceit, concealment, or trickery) by using the United States Postal Service (USPS) or any private or commercial interstate mail carrier, such as Mailboxes, Etc. Mail fraud may be committed against and by both businesses and individuals. A person commits mail fraud when he engages in a scheme to defraud, with intent to defraud, and uses the mails in furtherance of that scheme.

A scheme to defraud means depriving someone of property by deceitful or dishonest means. The scheme need not involve an affirmative misrepresentation or lie. And the property that is the target of the scheme can be tangible property (like money or real estate) or intangible property (like information or intellectual property).

Intent to defraud means that the defendant intends to be deceitful or dishonest. An individual cannot commit wire fraud if he believes his statements and actions were truthful and honest. Good faith is a defense.

Use of the mails in furtherance of the scheme means only that a mailing form a component of the scheme. The mailing need not be an essential element of the scheme. In other words, it’s not necessary that a fraudulent document be mailed or a false representation be made in a letter. It’s enough if the mailing is “incidental” to an essential element. And it is enough for the defendant to cause a mailing. He need not actually deposit the mailing in the mail.

Because the term, ‘scheme to defraud,’ is broadly defined, mail and wire fraud statutes forbid the use of mails or interstate electronics communication for schemes of fraud, enable the government to prosecute a very broad range of activities.

There are numerous types of mail fraud, which in the recent past included sellers of worthless distributorships, groups of attorneys and physicians who conspire to inflate medical expenses of accident victims, and holders of high office who accept bribes or extort kickbacks. The measure of fraud is nontechnical, involving general moral standards.

There are no technical implements with checks and balances before transmission of sensitive information, for example request for tax credits, property valuation documents, employment contracts or any documents that may be deemed sensitive in nature such that fraud upon them may lead to losses.

The aim of the current invention is to overcome technical limitations identified in the prior art to provide safe and secure verified mailing documents preparation and their transmission.

### SUMMARY OF THE INVENTION

The following summary is an explanation of some of the general inventive steps for the devices, methods and system in the description. This summary is not an extensive overview of the invention and does not intend to limit the scope beyond what is described and claimed as a summary.

Generally, the invention teaches of a system, method and apparatus for verified mailing documents and process preparation are disclosed. The disclosed comprise of a trusted agent, being a device adapted for secure verification of a person or entity that transmits a certified mailed document, a data source or engine from whose data a verified document may be generated, a mailing request recipient means adapted to receive requests to mail and/or transmit a certified document to an address of service, and a verification means to verify the authenticity of a requesting person or entity, preferably using biometric authentication means.

The current invention overcomes the deficiency of the prior art whereby sensitive documents may be transmitted without the recipient being sure that the document contents are verified as true, or that the sender of the documents only transmits verified documents, or that the data source used to generate such documents is a verified true source. The identified deficiency causes an inherent insecurity and fraud risk in such systems, and by extension, makes it unsafe to use mailing systems and has caused massive losses to thousands of people who have been target to fraud schemes.

According to one embodiment, a trusted agent comprises a computing device on whose memory is configured a program comprising a sequence of instructions, executable by at least a processor unit to verify the authenticity of a requesting person or entity, preferably using biometric authentication means.

According to one embodiment, a trusted agent comprises a computing device on whose memory is configured a program comprising a sequence of instructions, executable by at least a processor unit to obtain verified data from a data source and prepare a verified document for onward mailing.

According to one embodiment, a trusted agent comprises a computing device on whose memory is configured a program comprising a sequence of instructions, executable by at least a processor unit to transmit a mailing request to a mailing means adapted to receive requests to mail and/or transmit a certified document to an address of service.

According to one embodiment, the invention enables the generation of certified documents for onward transmission to a recipient, for example in credit report history building or updates.

According to one embodiment, the invention discloses a means of ensuring secure management of protected resources such as websites and other computer programs by verifying the authenticity of a requesting person or entity, preferably using biometric authentication means.

According to one embodiment, the invention discloses a verification means capable of verifying the authenticity of a requesting person or entity, preferably using biometric authentication means, such that a verified person or entity can transmit verified documents, or use a protected resource such as a website or other sensitive computer programs.

According to one embodiment, the invention discloses a distributed system architecture with a plurality of devices configured to pass messages between each other, and adapted towards a common function.

### BRIEF DESCRIPTION OF DRAWINGS

The novel features believed to be characteristic of the illustrative embodiments are set forth in the appended claims. The illustrative embodiments, however, as well as a preferred mode of use, further objectives and descriptions thereof, will best be understood by reference to the following detailed description of one or more illustrative embodiments of the present disclosure when read in conjunction with the accompanying drawings, wherein:

FIG. 1 of the diagrams illustrates the system apparatus of the invention comprising of a trusted agent, an authentication means, a network, a document preparation means, a trusted data source, a mailing service receiver and a mailing system (physical or electronic).

FIG. 2 of the diagrams is an illustration of the trusted agent embodied by a computing device.

FIG. 3 of the diagrams is an illustration of a process of preparation of a certified document by a trusted agent.

FIG. 4 of the diagrams is a flow chart illustrating a process of mailing a prepared certified document by a trusted agent.

### DETAILED DESCRIPTION OF THE DRAWINGS

Hereinafter, the preferred embodiment of the present invention will be described in detail with reference to the accompanying drawings. As such, the embodiments disclosed are only examples and this disclosure is not limited to these specific examples. Embodiments described in the following description may be incorporated into other systems and methods not disclosed in the following description. Structures, elements and process steps shown in the drawings are exemplary embodiments and are not to be used to limit broader teachings.

It is understood through the text of this disclosure that where elements or process steps are described as separate units, those skilled in the art will recognize that various elements or portions thereof may be integrated together. Where elements are described in the following description as integrated together into a combined element, those skilled in the art will similarly recognize that individual elements of the combination may be utilized as separate elements.

This specification includes reference to “an embodiment” or “one embodiment”. This language is intended to refer to the particular elements, structures and process steps of the embodiment being discussed in that portion of the specification. Where references are made to “an embodiment” or “one embodiment” in other portions of the specification, those similarly refer those particular elements, structures and process steps of the embodiment being discussed in that portion of the specification. Embodiments discussed in different portions of the specification may or may not refer to the same embodiment.

The use of specific terminology in the specification is used for best describing the invention and shall not be construed as limiting. The terms “include”, “including”, “comprise” and ″comprising” shall be understood to be open terminology and not limiting the listed items.

The terminologies or words used in the description and the claims of the present invention should not be interpreted as being limited merely to their common and dictionary meanings. On the contrary, they should be interpreted based on the meanings and concepts of the invention in keeping with the scope of the invention based on the principle that the inventor(s) can appropriately define the terms in order to describe the invention in the best way.

In this disclosure, the terms authentication system and authentication means may be used interchangeably, and will generally be directed at any such means of performing verification of the identity of a person using biometric means including but not limited to facial, fingerprint or any such.

In this disclosure, the terms trusted data source and verified data source may be used interchangeably, and will generally be directed at a source of data and/or documents that are verified as to the objective of mailing such documents.

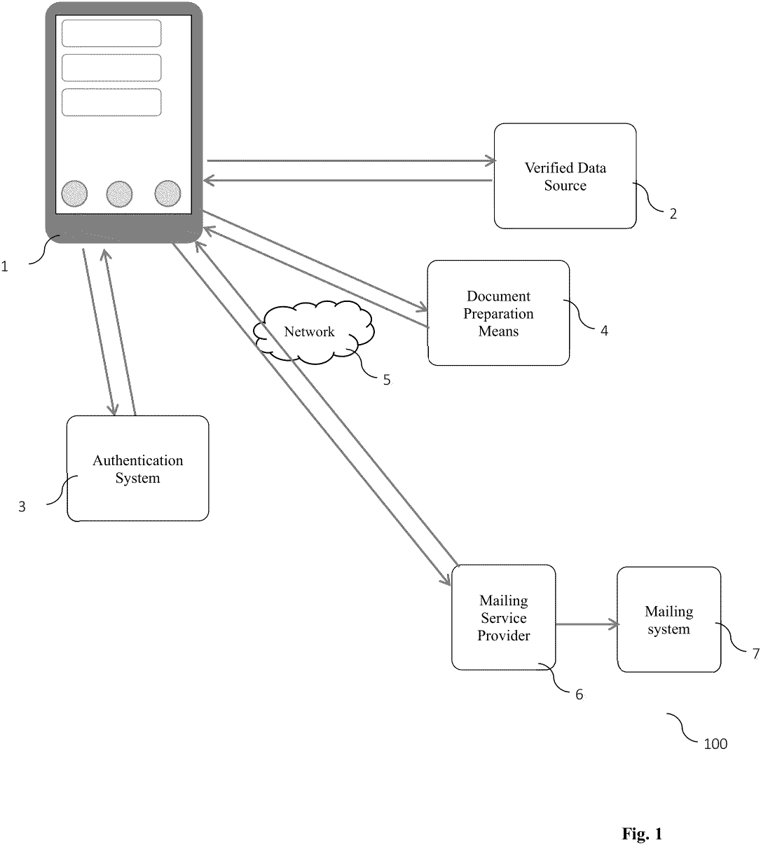

In a non-limiting embodiment according FIG. 1 of the diagrams, the apparatus and means of the invention are illustrated in a system 100. The featured of the apparatus comprise of a trusted agent 1, an authentication means 3, a network 5, a document preparation means 4, a trusted data source 2, a mailing service provider 6 and a mailing system (physical or electronic) 7. The system as disclosed is useful in improving the security of mailing systems, using both physical mailing systems as well as internet-based as well as other network and computer-based massaging system and reduce and or eliminate transmission of fraudulent in document transmission in such systems. For example, the system may be capable of facial, fingerprint or other biometric verification of a mail sender, to verify their identity before transmitting any mail documents. It may also ensure security of protected computer resources such as websites by ensuring resetting of passwords is only carried out after biometrically authenticating the identity of the requesting user. The system may also be specifically useful in ensuring that only certified and verified documents are transmitted to sensitive recipients such as in credit reference bureaus, where fraudulent documents could cause serious economic damage to the affected persons.

The trusted agent 1 embodied a portable computing device comprising a memory, processor, display and network communication means, and is adapted in the system as a trusted agent to authenticate the identity of a user of the system, prepare verified documents as requested by an authenticated user. The device is operably coupled to the authentication means 3, network 5, a document preparation means 4, a trusted data source 2 and mailing service provider 6. In an exemplary use case, a user wanting to generate a verifiable document, provides a biometric input such as a facial scan, iris scan, fingerprint or any such biometric indicators to the trusted device comprising a suitably configured program on its memory. The biometric indicator such as a facial scan, iris scan, fingerprint or any such are transmitted to the authentication means 3 via the network 5, where the biometric indicator is verified, validated and associated with a verified user who is known and thus unlikely to commit mail fraud. The authentication means 3 is a computer(s)/server(s) with a program disposed therein capable of validating and/or authenticating a biometric indicator by using previously stored biometric data.

On the other hand, and in a non-limiting embodiment, the document preparation means 4 comprises a data source of verifiable state, for example credit reference data, contract documents source, personally identifiable documents such as social security numbers and any such. For example, a person authenticated by the system’s authentication means may access a credit reference website within the context of the verified user, dispute listings on the website, and pull data related to the dispute for preparation of a verified dispute letter to be mailed to the credit reference bureau. The trusted agent 1 is adapted capable of performing the actions within a trusted setup such that the documents can be verified as having been sourced from a legitimate source, by a verified user whose details are known, and mailed and/or transmitted to a recipient that is the correct one for the type of certified documents.

Further, the mailing service provider 6 is provided to receive certified documents and the recipient, for onward transmission to the mailing system 7 (physical or electronic). The mailing service provider 6 may be a physical or virtual service provider that prepares the documents for onward mailing, for example by printing them, placing them in envelopes and labeling the recipient of the documents. The mailing system 7, may be a physical postal office or computer-based messaging system that can transmit documents to a recipient, including emails. The mailing service provider 6 may further comprise of a billing means such that the trusted agent may pay for the mailing service.

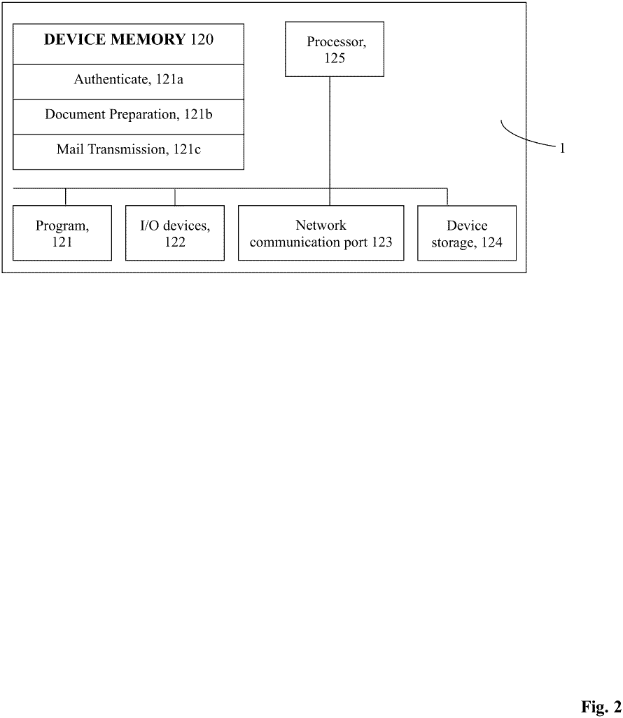

In the embodiment according to the FIG. 2 of the diagrams is an illustration of the trusted agent 1 embodied by a computing device. On the figure, it is illustrated a memory 120, program 121, input and output devices 122, network communication port 123, device storage 124 and processing unit 125. The memory 120 is capable of storing programmed institutions that can be executed by the processor unit 125, wherein the execution of the program may perform various methods of the invention such as authentication of a user using the authentication means, document preparation or mail preparation among others. The program 121 comprises a sequence of instructions configured on the memory as executable program modules such as authenticate 121a, document preparation 121b or mail transmission 121c. Input and output devices enable the device to receive instructions and provide responses to the received instructions. The device communicates to other devices, such as the authentication system via a network by means of the network communication port 123.

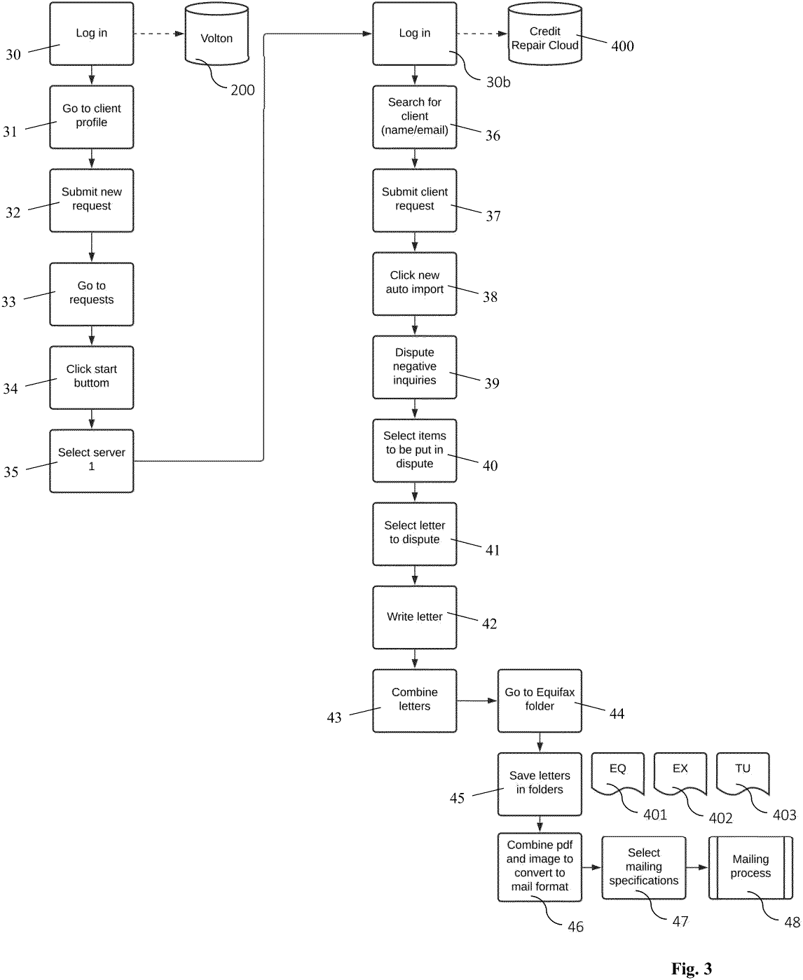

In the subsequent embodiment according to the FIG. 3 of the diagrams is an illustration of a process of preparation of a certified document by a trusted agent. For the avoidance of doubt, the source of documents could be credit reference data, contract documents source, personally identifiable documents such as social security numbers and any such. However, in this example, credit reference data has been used to illustrate the invention, but it should be understood that other data sources are also applicable and this does not intent to limit the invention. The first step 30 entails logging into a secured system 200, and in 31, navigating through the profile provided on the trusted device on which they are logged in. The user then may submit a request to prepare a document as in 32, and then access such a request as in 33, where they may initiate the process by the means 34, where after they can select the data source in a step 35. the user can then login securely and verifiably to the data source in the step 30b, which for purposes of this embodiment is a credit repair cloud 400, which has data on the credit history of the securely logged user.

Further along the process, the details of the logged client may be searched as in 36 so as to pull the credit information, for example by email, name, phone number, identification number, social security number or any other means, and the search request submitted to the credit repair cloud 400 in 37. The request is received and data pulled by the credit repair cloud 400 and the use proceeds to import the credit reference data in step 38. The user may then process to dispute listing in their credit data as pulled from credit repair cloud 400 and in context of the secure trusted agent and verified user, and thereafter, select items to be placed in their dispute letter as in step 40, and then proceed to select letter to dispute the data in their ratings profile in 41 and then write a dispute letter in 42. it is anticipated that the program installed in a trusted agent may be capable of writing a letter, but in some embodiments, the user may have to write the letter by themselves and include the data pulled from the credit repair cloud 400.

In some cases, as in the example shown, there may be multiple recipients such as Equifax (EQ) 401, Experian (EX) 402 or TransUnion (TU) 403, and as such, the step of combining the letter as in 43 may be necessary. For each recipient, the letter shall be stored in a folder dedicated for the recipient such as Equifax (EQ) in step 44 and saved as in 45 in the respective folder. Thereafter, for each saved letter, it is converted to a mailing format in the step 46, and the mailing specifications selected in 47, for example to be sent as a letter, a card, a flyer, brochure or any other format in preparation for the actual transmission in the mailing process 48. The mailing process 48 may be via a physical post office, where the documents are physically printed, sealed, addressed and shipped to the recipients, or electronically, where the documents are transmitted via electronic means.

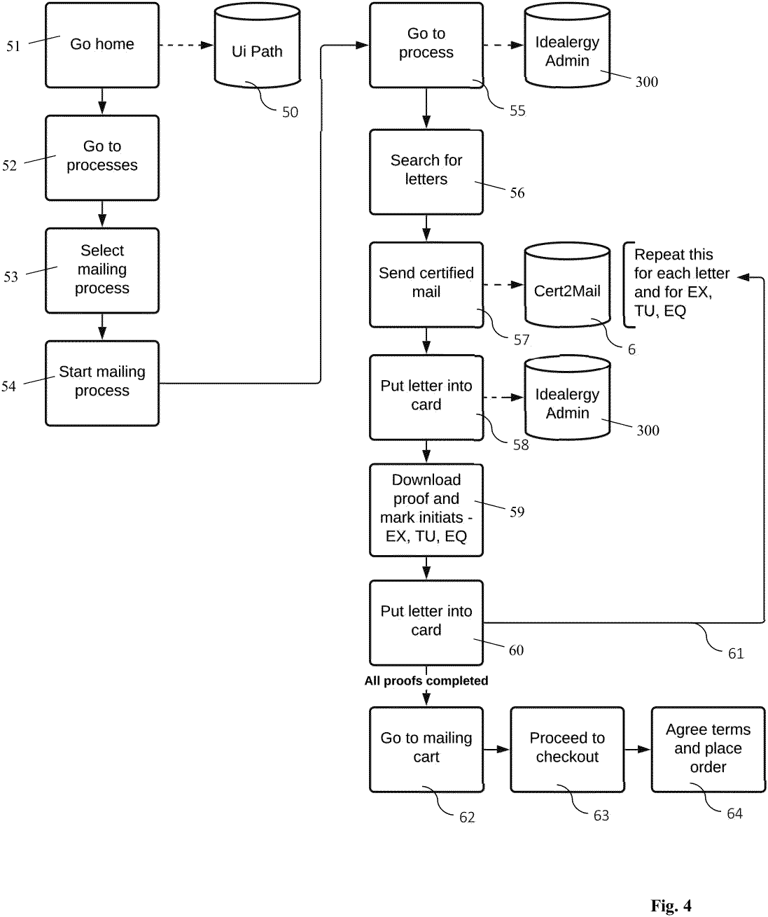

In the subsequent exemplary embodiment according to the FIG. 4 of the diagrams is a flow chart illustrating a process of mailing a prepared certified document by a trusted agent. On the trusted device (agent) is a UI (user interface) path 50, which enables the user to utilize the features of the device to benefit from the invention. On the provided user interface, the user may access the home page in the step 51, where they can access system processes as in 52 to select the mailing process in the step 53 and start the mailing process in step 54. Subsequently, upon access the trusted agent’s processes from the trusted agent administration process 300 in 55, the user may search for the prepared letters in the step 56 for onward transmission 57 to the mailing service provider 6. The trusted agent administration process 300 places the letter into card in a process 58 in preparation for downloading proof for each document intended for all recipients in the step 59. In this case, the letters were prepared for multiple recipients such as Equifax (EQ) 401, Experian (EX) 402 or TransUnion (TU) 403. Subsequently, the letter is put into card in the step 60 and transmitted to the mailing service provider 6 in the step 61. Thereafter, the user may select a mailing process 62, then checkout by making the payment for the payment service after agreeing to the terms and conditions in the step 64.

It is anticipated that the invention enables the provision of tamper-proof receipts for payments towards dynamic transaction assets.

It is anticipated that in the encoding of transaction assets by a merchant terminal, the encoded asset is identifiable by either a referral key or a portion thereof.

It is anticipated that in the decoding of transaction assets as encoded by a merchant terminal, the decoding device may use either a referral key or a portion thereof.

It is anticipated that the invention discloses a distributed system architecture, an event-driven architecture, a service oriented architecture, a complex system architecture with a plurality of devices configured to pass messages between each other, and adapted towards a common function or a monolithic system architecture

Although a preferred embodiment of the present invention has been described for illustrative purposes, those skilled in the art will appreciate that various modifications, additions and substitutions are possible, without departing from the scope and spirit of the invention as disclosed in the accompanying claims. Such alterations are herewith anticipated.

### INDUSTRIAL APPLICATION

The current invention technology useful in improving the accuracy of payment and banking processes in relation to merchants and payments.

Further, the current invention is useful in providing tamper-proof receipts for payments towards transaction assets that are dynamic in nature rather than static non-altering.

What is claimed is:

1. A system for verified mail documents and process preparation comprising of:
a computing device adapted as a trusted agent, being configured capable of verifying the identity of a user and conducting requests within a trusted context;
a network;
a biometric authentication means coupled to the trusted agent;
a document preparation means, capable of receiving data from a verified data source and prepare it for transmission as a mail;
a verified data source;
a mail service provider; and
a mailing system.

2. The system in claim 1, wherein the trusted agent is adapted to receive a biometric indicator for a user verification.

3. The system in claim 2, wherein the trusted agent is adapted to initiate process to pull and prepare verified data from a trusted source for a verified user in a trusted context.

4. The system in claim 1, wherein the mail service provider is adapted to package documents into letters for onward transmission by a mailing system.

5. The system in claim 1, wherein the mailing system is a physical post office.

6. The system in claim 1, wherein the mailing system is an electronic mailing system.

7. The system in claim 6, wherein mailing system is email or any such computer-based mailing system.

8. The system in claim 1, wherein the biometric authentication means is adapted to store biometric data of a user that may include at least in part facial scans, iris scans, fingerprints or any such biometric data unique to a person.

9. A method of preparing certified and verifiable documents for mailing in a mail system, the method comprising the steps of:
using biometric means to authenticate to a trusted agent;
requesting by means of a trusted agent data from a trusted data source coupled to said trusted agent;
receiving at the trusted agent data from a trusted data source;
preparing a certified document by the trusted agent; and
transmitting to a mail service provider the prepared certified document for onward transmission to a recipient via a mailing system.

10. The method of claim 9, further comprising labeling the recipient of the certified document by said mail service provider.

11. The method of claim 9, further comprising storing the certified document as a letter for the recipient in a corresponding folder in the trusted agent.

12. The method of claim 9, wherein the process is carried out by the trusted agent.

13. The method of claim 9, further comprising specifying the type of letter such as a flyer, brochure, letter, pamphlet among others.

14. The method of claim 9, further comprising receiving the certified document at a mailing service provider for onward transmission to a mailing service.

15. A method of providing a system for verified mail documents and process preparation comprising of:
providing a computing device adapted as a trusted agent, being configured capable of verifying the identity of a user and conducting requests within a trusted context;
providing a network;
providing a biometric authentication means coupled to the trusted agent;
providing a document preparation means, capable of receiving data from a verified data source and prepare it for transmission as a mail;
providing a verified data source;
providing a mail service provider; and
providing a mailing system.

16. The method of claim 15, wherein the provided trusted agent is adapted to receive a biometric indicator for a user verification.

17. The method of claim 15, wherein the provided trusted agent is adapted to initiate process to pull and prepare verified data from a trusted source for a verified user in a trusted context.

18. The method of claim 15, wherein the provided mail service provider is adapted to package documents into letters for onward transmission by a mailing system.

19. The method of claim 15, wherein the provided mailing system is one or more of a physical post office, an electronic mailing system, email or any such computer-based mailing system.

20. The method of claim 15, wherein the provided biometric authentication means is adapted to store biometric data of a user that may include at least in part facial scans, iris scans, fingerprints or any such biometric data unique to a person.
